(19) United States
(12) Patent Application Publication
(10) Pub. No.: US 2006/0080277 A1
(43) Pub. Date: Apr. 13, 2006

(54) Method and system for designing, implementing and documenting OLAP

(76) Inventor: Peter Nador, Ottawa (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/241,933

(22) Filed: Oct. 4, 2005

Related U.S. Application Data
(60) Provisional application No. 60/615,018, filed on Oct. 4, 2004.

(51) Int. Cl. G06F 17/30

(52) U.S. Cl. 707/1

(57) ABSTRACT

A system for assisting in the design, implementation and documentation of an online analytical processing system provides a plurality of extractor programs for extracting data from the online analytical processing system, and transferring the data to at least one extracted data table. The extracted data table serves as an information source for a master information cube that stores data for permitting users to generate reports about the design, implementation and documentation of the online analytical processing system.

### CROSS-REFERENCE TO RELATED APPLICATIONS

This application claims the benefit of priority under 35 U.S.C. §119(e) to U.S. Provisional Patent Application Ser. No. 60/615,018 filed Oct. 4, 2004.

### MICROFICHE APPENDIX

Not Applicable.

### TECHNICAL FIELD

This invention relates in general to Online Analytical Processing (OLAP) Systems, and in particular to a method and system for assisting in the design, implementation and documentation of an OLAP system.

### BACKGROUND OF THE INVENTION

A core of an OLAP system accepts, transforms and organizes data in a manner suited for interactive analytical reporting. There are many OLAP systems known in the art such as Oracle, Cognos, SAP, etc. For the sake of a well known example, in the description that follows reference will be made to SAP AG's Business Information Warehouse (SAP-BW).

A generic flow of information in an OLAP system is shown in FIG. 1a. As shown in FIG. 1a, data from a source file referred to as an “original file” 20 is fed to a data extractor 22 which transforms data from the original file 20 to a format 24 suitable for presentation to the OLAP system. The incoming data 26 is transferred by a transfer function 28 that modifies the data in any necessary way before it is presented to a temporary staging function 30 that passes the data to a change function 32. The change function 32 further reformats the data as required before storing it in a reporting database 34. Users query the reporting database 34 to extract information (reports 36) required by development, maintenance and business managers. The data is captured, transferred and stored in predefined data fields 38. FIG. 1b shows the flow of information shown in FIG. 1a, expressed in specific terminology used by those skilled in the art when referring to the SAP-BW.

Data enters the system from many and varied external sources (DataSources). This data is loaded into “InfoCubes”, which are multidimensional data structures. Reporting is based on data stored in the “InfoCubes”.

Data can also be loaded into Operational Data Store (ODS) objects and into Master Data tables. These are collectively called “Data targets”. However, this document uses the term “InfoCube” to refer to “data targets” of any type for the sake of simplicity to facilitate understanding.

Data from “DataSources” is received by “InfoSources”. Transfer rules “in “InfoSources” transform the incoming data and make the transformed data available to “InfoCubes” via their “communication structures”.

A DataSource can feed one or more “InfoSources”. An InfoSource can receive data from one or more DataSources. An InfoSource can feed one or more InfoCubes. An InfoCube can receive data from one or more InfoSources.

Data content and applicable processing rules are expressed in terms of “Characteristics” and “Key Figures” collectively called “InfoObjects”. Key Figures are usually numbers, like salary, quantity, etc. Characteristics are qualifiers of numbers, such as: material ID, personal ID, vendor ID, etc. Characteristics can have “attributes”, such as: address of a customer; birth date of a person, etc.

Attributes in SAP-BW can be time dependent and also can be classified as “navigational” i.e. attributes can be used in queries to direct a format of a report. To further complicate matters, the fact that an attribute is designated navigational for a certain characteristic does not mean that in any given “InfoCube” it retains that designation.

This description of the SAP-BW is not intended to be complete. It is meant only to illustrate the complexity of the SAP-BW data model. Because of this complexity it is a significant challenge to: design, document and create a common understanding during a design phase of how a data model will be structured; communicate the existing data model to users, analysts and implementers; understand and communicate to all participants the effects of a change in the data model structure; and integrate new members into an SAP-BW team.

These factors influence the time required to implement and maintain a SAP-BW system, the number of errors due to misunderstanding, and an overall cost of design and maintenance.

These challenges arise in three main areas associated with: the design phase when no system exists as yet; the implementation phase, when the system is being constructed; and the maintenance phase, when an operating system exists.

FIG. 1c illustrates how metadata is displayed in a SAP-BW system metadata repository about an InfoCube “Sales” in the SAP-BW. In order to obtain information about a single InfoCube, a user must first display screen 1 and screen 2 to select the InfoCube of interest, i.e. Sales. When Sales is selected from the screen 2, screen 3 is displayed. Screen 3 shows information about the contents of the InfoCube. In order to display details of each characteristic that is included in the InfoCube, a plurality of screens must be displayed, one of which (screen 4) is shown. It is impossible to view details of all characteristics of an InfoCube concurrently. The user can also view an information flow that delivers data content to the InfoCube by selecting “network display of data flow” which displays screen 5.

As is understood by those skilled in the art, the information shown in FIG. 1c is available only for the selected InfoCube. If other information about individual components of the InfoCube is required, additional inquiries must be performed to display other screen displays. It is not possible to automatically compile the information shown in screens 1-5 of FIG. 1c for several InfoCubes in a single report. This can only be done manually. The same holds true for information about InfoSources as shown in FIG. 1d where screen 40 must be accessed to select the InfoSource “orders”, which displays screen 42 that provides options for selecting other display screens in a manner similar to that described above with respect to FIG. 1c.

FIG. 1e shows how the SAP-BW metadata repository displays information about Update Rules, which are processes that connect InfoSources to InfoCubes. The format and contents of the display screen 44 cannot be changed by the user.

FIG. 2a illustrates a typical prior art design process. Since the data model of an SAP-BW system 50 is common to users 52, analysts 54, designers 56 and implementers 60, a change in any part of the SAP-BW system 50 affects all modules and participants 52-60 in the project. There is therefore a need to ensure that design decisions are uniformly understood by all. Another characteristic of SAP-BW system 50 is that participants 52-60 can change. Consequently, there is a need for good system documentation to permit new participants to learn quickly about the structure of the OLAP system. Good documentation is generally a neglected part of information technology projects.

While a SAP-BW metadata repository does generate documentation information, this information is fragmented, as explained above with reference to FIGS. 1c-1e, and it requires significant amount of time and experience to produce and integrate into a format required for design and system analysis. This is typical of all known OLAP systems.

This demonstrates a need to support and disseminate changes in terminology as an OLAP design process progresses; communicate changes made in the OLAP design and/or in the OLAP system to all participants; and enable each participant to assess the effects of their initiatives on total OLAP system capabilities and configuration.

There therefore exists a need for a method supported by automated tools to improve the effectiveness and efficiency of OLAP design and maintenance processes to ensure completeness and quality of communication among participants in an OLAP system.

### SUMMARY OF THE INVENTION

In accordance with a first aspect of the invention there is provided a system for assisting in the design, implementation and documentation of a subject online analytical processing system, comprising: a plurality of extractor programs for respectively extracting data from one of: a table of the subject online analytical processing system, and a view of two or more of the tables; and an extracted data table for receiving data extracted by the plurality of extractor programs, the extracted data table serving as an information source for a master information cube of a host online analytical processing system that stores data for permitting users to generate reports about the online analytical processing system.

In accordance with another aspect of the invention there is provided a method of assisting in the design, implementation and documentation of a subject online analytical processing system, comprising: providing a plurality of extractor programs for respectively extracting data from one of: a table of the online analytical processing system, and a view of two or more of the tables; providing at least one extracted data table for receiving data extracted by the plurality of extractor programs, each extracted data table serving as an information source for a master information cube of a host online analytical processing system that stores the data; and structuring data staging facilities of the host online analytical processing system to transfer the data from the extracted data table to the master information cube to permit users to generate reports about the online analytical processing system.

### BRIEF DESCRIPTION OF THE DRAWINGS

Further features and advantages of the present invention will become apparent from the following detailed description, taken in combination with the appended drawings, in which:

FIG. 1a is a schematic diagram of data flow in a prior art OLAP system, using generic terms;

FIG. 1b is a schematic diagram of the data flow in the prior art SAP-BW, using specific SAP-BW terminology;

FIG. 1c is a schematic diagram illustrating how metadata is displayed in a SAP-BW “metadata repository” associated with an InfoCube “Sales”;

FIG. 1c is a reproduction of a screen display illustrating how metadata is displayed in the SAP-BW metadata repository for InfoObject “Material Number”;

FIG. 1d is a reproduction of a screen display illustrating how metadata is displayed in the SAP-BW metadata repository for InfoSource “Orders”;

FIG. 1e is a reproduction of a screen display illustrating how metadata is displayed in the SAP-BW metadata repository for Update rule “ZXDSALES-ZIDORDERS”;

FIG. 2a is a schematic diagram of a system design process representing in general terms a typical workflow in a prior art OLAP system development project;

FIG. 2b is a schematic diagram of a system design process in accordance with the invention illustrating a role a system in accordance with the invention plays in a typical OLAP system design process;

FIGS. 3a and 3b are schematic diagrams showing principal components of one embodiment of the invention and a high level dataflow between components;

FIG. 3c is a schematic diagram illustrating how data is extracted from tables of the OLAP system and transferred to a master information cube in accordance with the invention;

FIG. 4a is a reproduction of a principal worksheet for a design environment in accordance with the invention, which in one embodiment is an Excel® spreadsheet with control buttons used to personalize a way in which the spreadsheet is displayed to different users;

FIG. 4b is a reproduction of the design environment spreadsheet personalized for “Joan”;

FIG. 4c is a reproduction of the design environment spreadsheet personalized for “George”;

FIG. 5 is a reproduction of an example of output of an extractor in accordance with the invention for transferring data from the design environment spreadsheet to an OLAP design database;

FIG. 6 is a reproduction of a sample report generated using an InfoCube in accordance with the invention;

FIG. 7 is a reproduction of a sample report generated using the InfoCube in accordance with the invention, showing only key figures where Update rules use formulas (F) or routines (R) and further showing a navigational window of the report; and

FIG. 8 is a reproduction of a report shown in FIG. 6 illustrating a location of information displayed in the screens shown in FIGS. 6 through 9.

It will be noted that throughout the appended drawings, like features are identified by like reference numerals.

### DETAILED DESCRIPTION OF THE PREFERRED EMBODIMENT

The invention provides a system and method for assisting in the design, implementation and documentation of a subject online analytical processing system. The system includes a plurality of extractor programs for respectively extracting data from one of a table of the subject online analytic processing system and a view of two or more of the tables. The system further includes an extracted data table for receiving the data extracted by the plurality of extractor programs. The extracted data table serves as an information source for a master information cube that stores data for permitting users to generate reports about the subject online analytic processing system. In accordance with the invention, data staging facilities of a host online analytical processing system are structured to transfer the data from the extracted data table to the master information cube to permit users to generate the reports about the online analytical processing system using the query and reporting system of the host online analytical system to generate the reports in response to user queries.

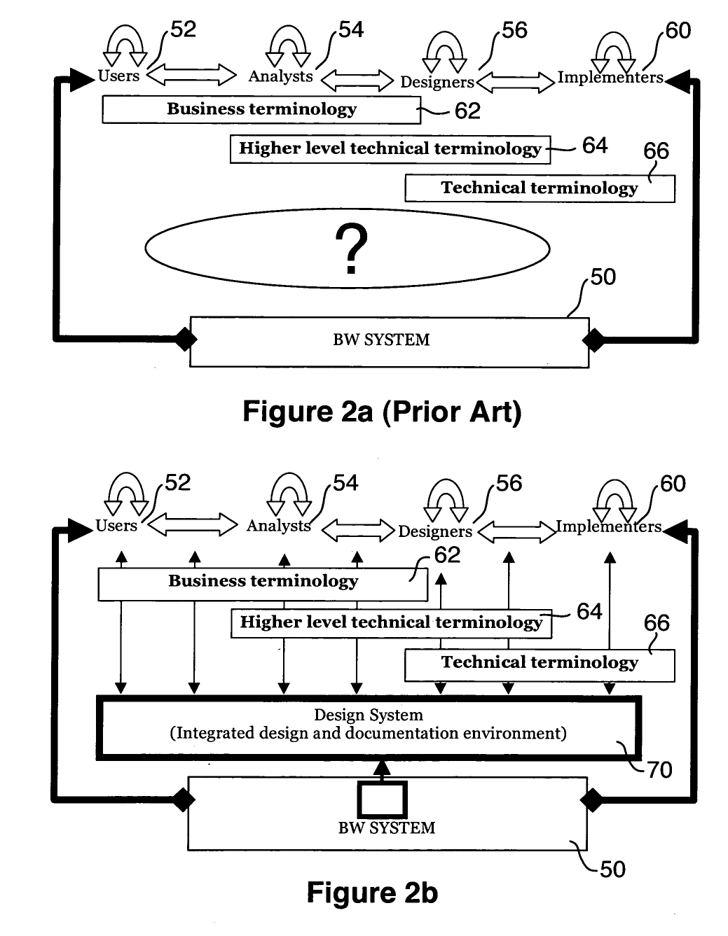

FIG. 2b is a schematic diagram of how a system in accordance with the invention (design system 70) integrates with a typical OLAP design process. As will be appreciated by those skilled in the art, the design system 70 receives information from the business warehouse system 50 as well as from users 52, analysts 54, designers 56 and implementers 60. The information includes business terminology 62; higher level technical terminology 64; and technical terminology 66. Information is received by the design system 70 through development and documentation by the users 52, analysts 54, designers 56 and implementers 60. Information is fed back to the users 52, analysts 54, designers 56 and implementers 60 in the form of reports as will be explained below in more detail.

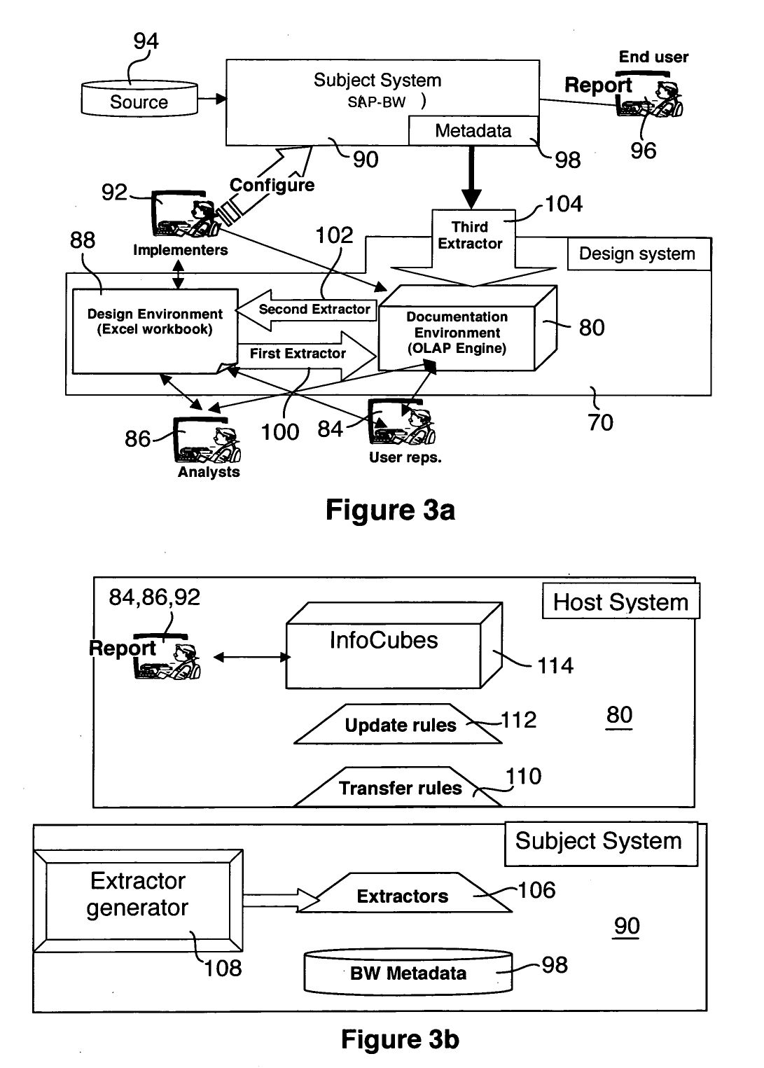

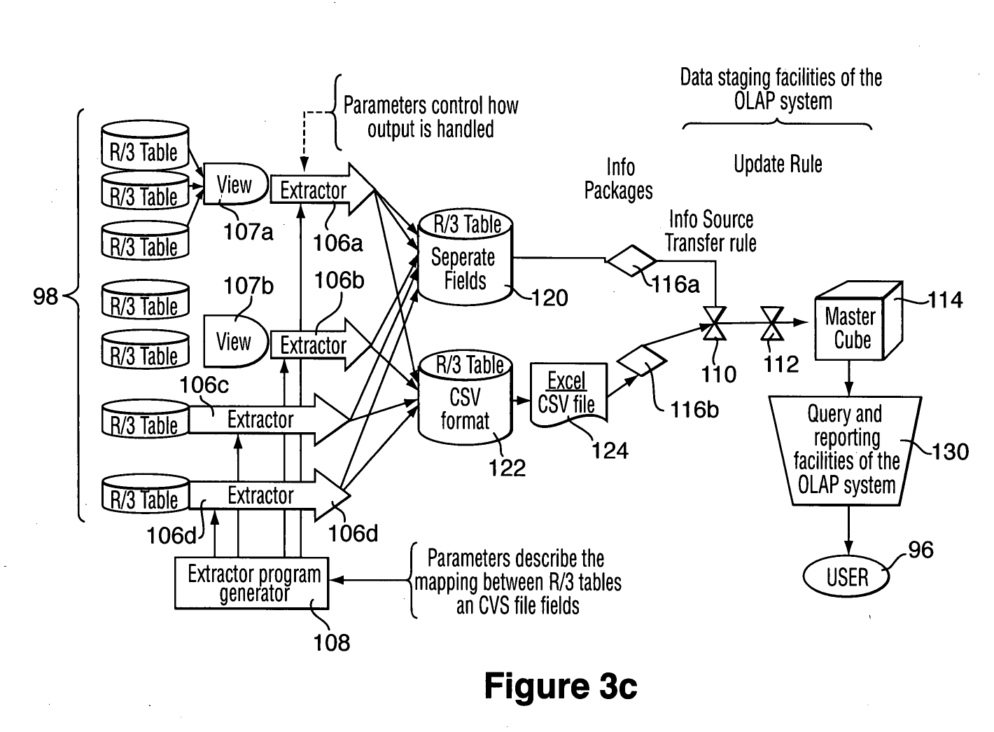

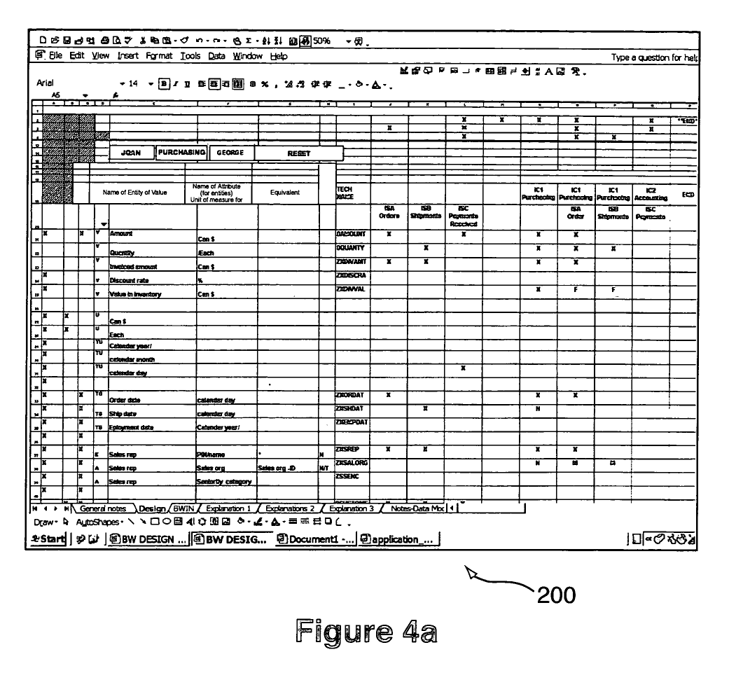

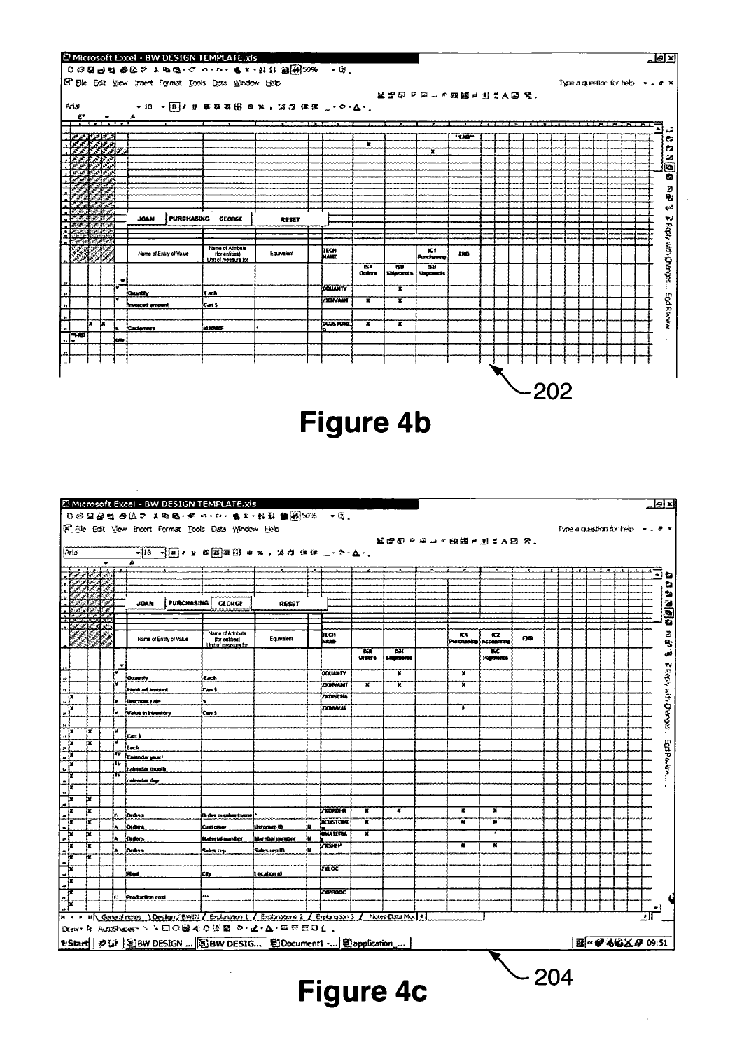

FIG. 3a is a block diagram illustrating principle components of the design system 70 and its relationship with a subject OLAP system, in this example SAP-BW. The design system 70 includes a documentation environment 80, which is implemented using an OLAP engine. The documentation environment receives data via a data extractor (third extractor 104) from the metadata files 98 of the subject system 90. A second extractor 102 extracts information from the documentation environment 80 to create a design environment which in one embodiment is implemented using an Excel® spreadsheet (workbook 88). Information from the Excel® spreadsheet is extracted by a first extractor 100 and deposited in the documentation environment 80. User representatives 84 contribute information via extractors, as will be explained below with reference to FIG. 3c, to the documentation environment 80. User representatives 84 likewise submit queries to the documentation environment 80 and receive reports as will be explained below in more detail with references to FIGS. 4-12.

Implementers 92 configure the subject OLAP system 90 in a manner well known in the art using information derived from the design environment 88 and the documentation environment 80. The configuration of the subject system 90 likewise creates metadata 98, which is extracted by the third extractor 104 and fed to the documentation environment 80. Application data is derived from sources 94 and fed to the subject system 90. Users 52 send queries to the subject system 90 and receive reports 96 from the subject system 90 about the information fed in from the sources 94.

FIG. 3b is a high level overview of principle components of a system in accordance with the invention. As briefly explained above, the system in accordance with the invention can be divided into components implemented using the subject OLAP system 90 and those using the host OLAP system 80. It should be understood that the subject system 90 and the host system 80 may be one in the same. Alternatively, the subject system 90 and the host system 80 may be different OLAP systems, which enhances portability of the host system 80.

As shown in FIG. 3b, extractors 106 developed using facilities of the subject system 90 extract information from the subject system metadata database (BW metadata 98). Information extracted from the BW metadata 98 is fed via transfer rules 110 and update rules 112 to one or more InfoCubes 114 which make up the documentation environment 80 shown in FIG. 3a. User representatives 84, analysts 86 and implementers 92 send queries to the InfoCubes 114 in a manner well known in the art and receive reports respecting the configuration of the subject system 90, as will be explained below in detail. An extractor generator 108 generates the extractor programs 106 required to extract information from the BW metadata 98, as will be explained below with reference to FIG. 3c.

FIG. 3c is a schematic diagram illustrating how data is extracted from the subject system BW metadata 98 and fed to one or more master cubes 114 of the host system 80, as described above with reference to FIG. 3b. The heart of the documentation environment 80 is the multidimensional information cube (InfoCube 114), which can be implemented using most OLAP systems. As explained above, the system illustrated by way of example is the SAP AG Business Information Warehouse (SAP-BW). In the SAP-BW, the subject system BW metadata 98 is stored in R/3 tables. Extractors 106a-106d extract information either directly or indirectly from the subject system BW metadata 98. Views, 107a and 107b in this example, are used to combine data from two or more metadata tables in order to increase utility and versatility. As will be understood by those skilled in the art, although the views 107a, 107b are shown receiving data from different tables, any table can be a source of information for one or more views.

The extractors 106a-106d in one embodiment are ABAP programs. The outputs of the extractors in one embodiment are captured in R/3 tables 120, 122 that are different only in their data format. The table 122 includes a named field corresponding to each field output by the respective extractors 106a-106d. The table 122 is in “CSV” format, which is a comma-delimited file format well known in the art. Table 122 therefore includes only a single record. The record consists of concatenated values of all output fields separated by commas or semicolons, in a manner well know in the art. The information content of tables 120 and 122 is identical.

Each extractor 106a, 106b is a program that is executed to extract data from a view 107a, 107b or directly from a BW metadata 98 table. In one embodiment, each extractor run is identified by an extractor ID and a unique run number. The table/view from which information was extracted is also included. Control parameters for each extracted run enable control of how the output tables are managed. Control options include: delete all contents of the tables before running the extractor; delete a specific run under a specific extractor; append the output to the current content of the tables 120, 122. Information from the tables 120, 122 is loaded in the master cube 114 using data staging facilities of the OLAP host system. As will be understood by those skilled in the art, the SAP-BW staging facilities include information packages 116a, 116b which describe a location and format of the respective tables 120, 122 and may likewise filter information transferred from the respective tables. Information source transfer rules 110 and update rules 112 function to control data transfer and transformation in a manner well know to those skilled in the art.

The extractors 106a-106d have been implemented to load BW metadata 98 for selected components of the SAP-BW configuration. In one embodiment, the data is restricted to description of the elements so that users 96 can display textual descriptions and/or technical names as required. Each extractor 106a-106d creates a unique record type in the master cube 114. However, common information objects between record types are created to ensure meaningful reporting.

In one embodiment of the invention, the extractors 106a-106d are ABAP programs that are automatically generated by the extractor program generator 108. Input parameters for the extractor program generator 108 provide mapping between input fields, i.e. fields of the BW metadata 98 tables and/or views 107a, 107b and the fields of the output tables 120, 122. Special subroutines in the extractor program generator 108 create the ABAP code for each extractor program 106a-106d using the input parameters for the respective extractors. As will be understood by those skilled in the art, the mapping parameters are only required when a one-to-one mapping between input and output fields does not exist. The extractor program generator 108 permits rapid and accurate generation of all required extractor programs 106a-106d. Reporting from the master cube 114 is performed using the query and reporting facilities 130 of the host OLAP system.

The invention will now be further explained with reference to FIGS. 4a-8, which are reproductions of screen displays of outputs from the host system 80 in accordance with the invention. FIG. 4 is a reproduction of a sample design environment workbook 88 (see FIG. 3a) which is created in one embodiment as an Excel® spreadsheet using output from table 122 to create an Excel® CSV file 124 (see FIG. 3c). In this embodiment, the Excel® spreadsheet 200 is provided with a plurality of control buttons labeled “Joan”, “purchasing”, “George”, and “Reset”. The control buttons are used to personalize a display of the spreadsheet 200 as will be explained below in more detail.

FIG. 4b is a reproduction of 202 of the spreadsheet 200 shown in FIG. 4a when the button “Joan” is selected to personalize the spreadsheet 200 display for Joan.

FIG. 4c is a reproduction 204 of the spreadsheet 200 when the control button “George” is selected to personalize the workbook for George. Any number of control buttons can be added to the design environment workbook 88 to permit any one of users 52, analysts 54, designers 56 and implementers 58 to view a design environment workbook 88 tailored to their specific needs. The control buttons are created by inputting parameters using Excel® facilities well understood by persons skilled in the art. This personalization reduces complexity, permits individuals to concentrate on their area of responsibility and correspondingly reduces errors.

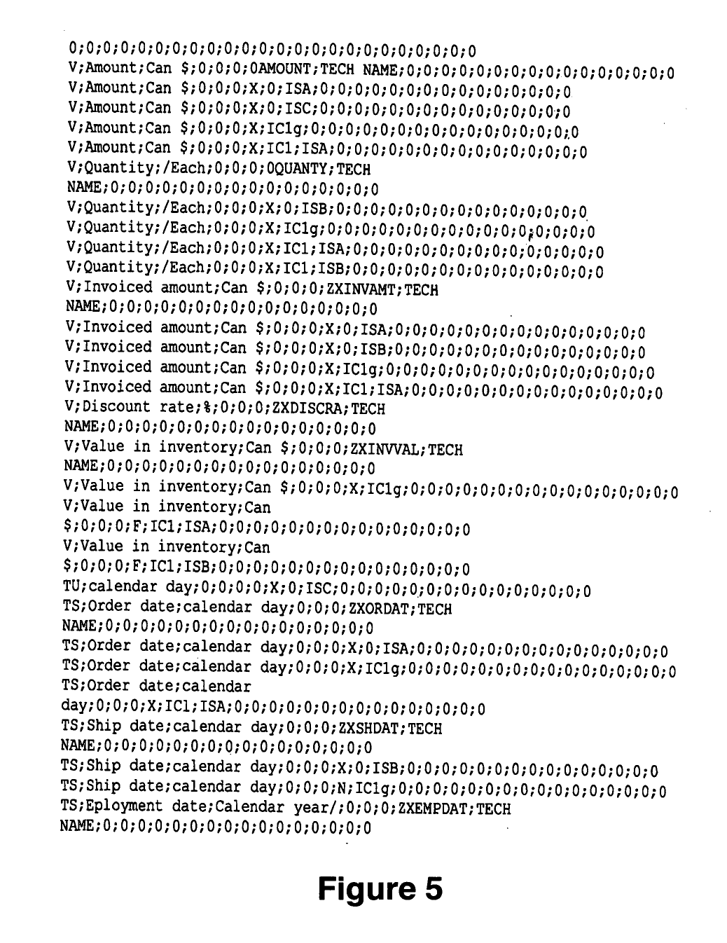

FIG. 5 is a sample output of the first extractor 100 (FIG. 3a) transferring data from the design environment workbook 88 to documentation environment 80 (FIG. 3a) so that changes made by user representatives 84, analysts 86, or implementers 92 is reflected in the documentation environment 80 and used by implementers 92 to configure the subject OLAP system 90 as explained above with reference to FIG. 3a.

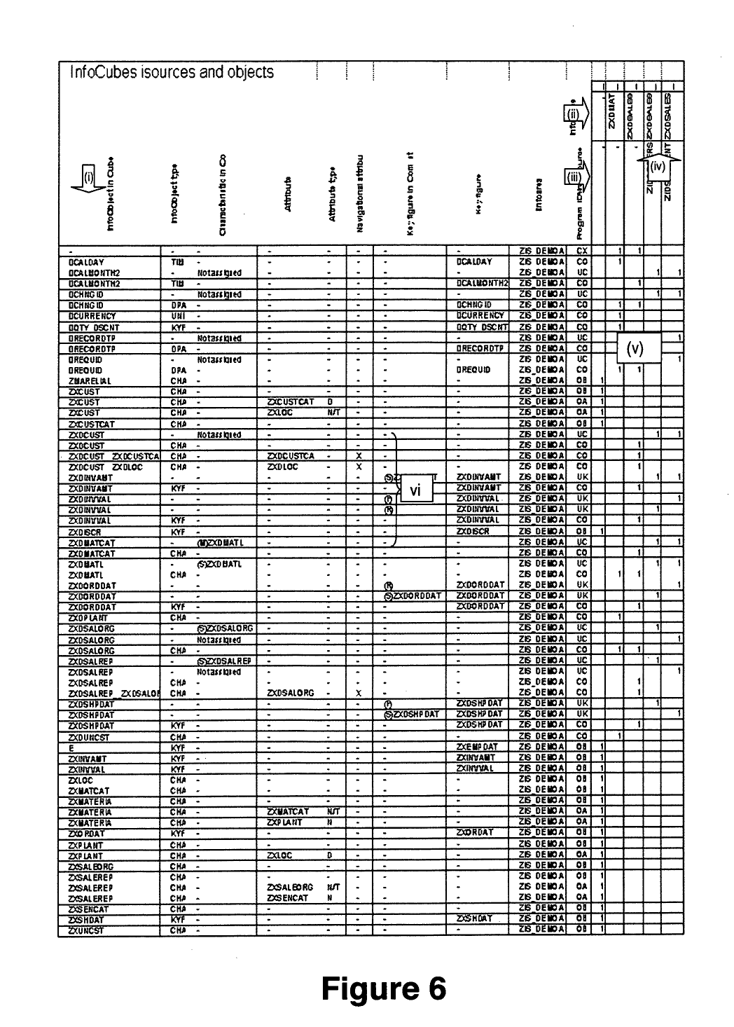

FIGS. 6-8 illustrate how the system in accordance with the invention displays documentation and design information. The figures show a single report that can be produced using the system in accordance with the invention. Users 52 can change the content and format of reports to suit their individual needs. The users 52 are limited only by the facilities provided by the particular OLAP host system selected to implement the invention. FIGS. 6-8 are based on a simple implementation model built using the SAP-BW host system 80.

FIG. 6 shows a sample report produced from the InfoCube 114 shown in FIG. 3c. The report displays at (i) all InfoObjects in a selected portion of the subject system 90; at (ii) all InfoCubes in the selected portion of the subject system 90; at (iii) all InfoSources in the selected portion of the subject system 90; at (iv) all existing connections between InfoCubes and InfoSources in the selected portion of the subject system 90; at (v) an indication of which InfoObject is included in which InfoCube and from which InfoSource the InfoObject was derived in the selected portion of the subject system 90; and at (vi) the way in which update rules fill in values of an InfoObject, e.g. direct replacement, formula, routine, etc.

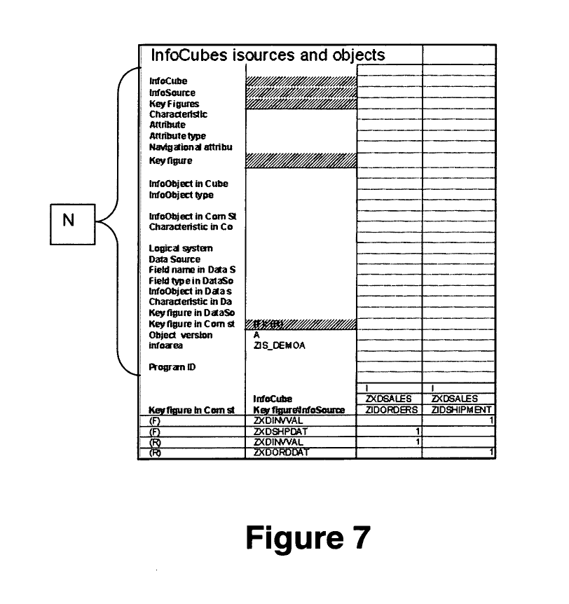

FIG. 7 is a reproduction of an example of the report shown in FIG. 6 where a user 52 selected an option to see only those items where the update rules used either a formula (F) or a routine (R) to fill an InfoObject in the InfoCube. This is indicated in the navigation window (N), which illustrates flexibility provided to the user to customize the contents and/or format of the report shown in FIG. 6.

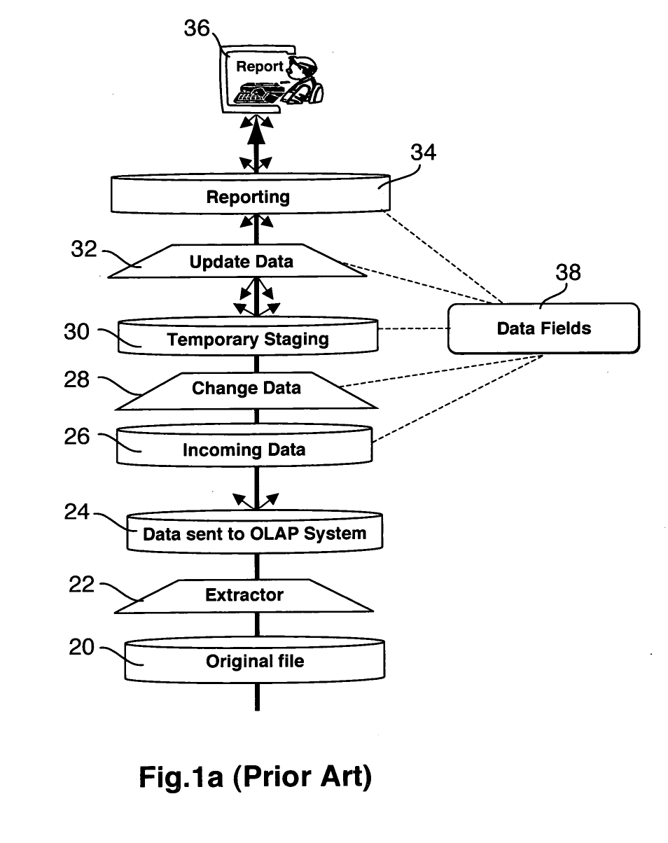

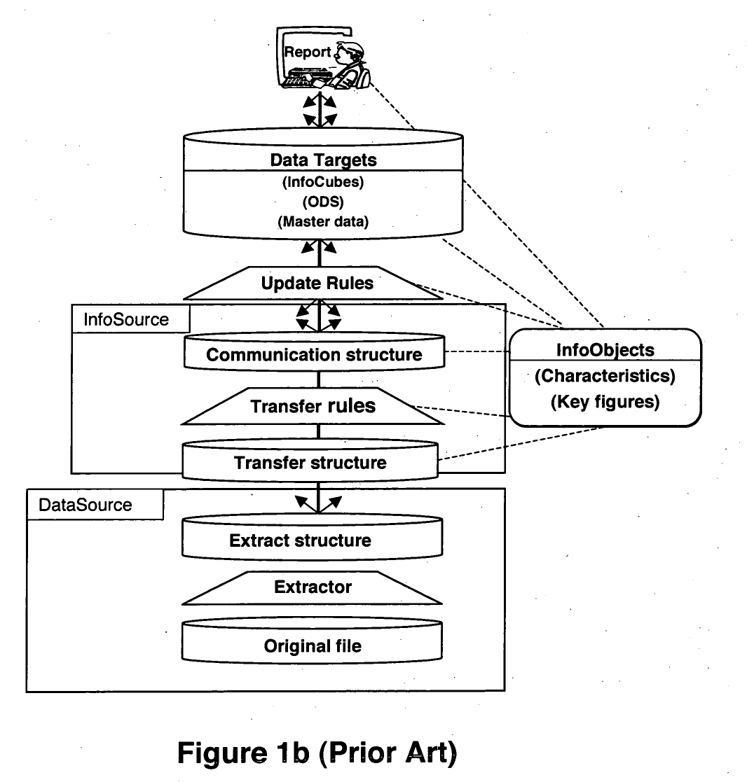

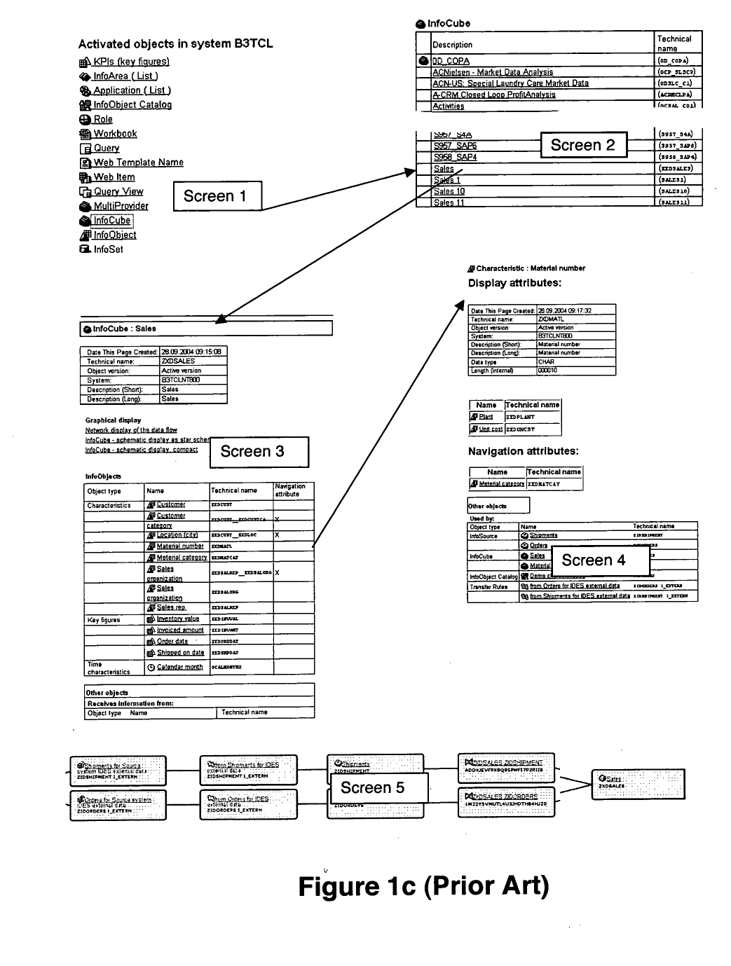

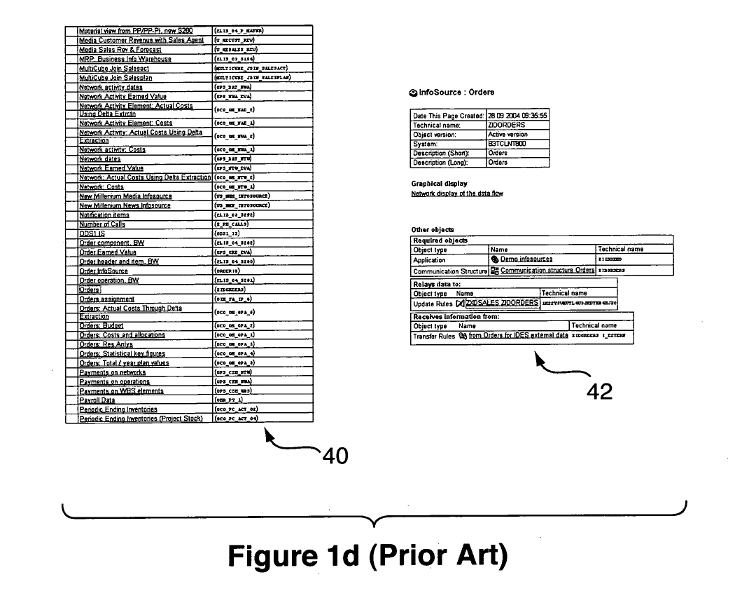

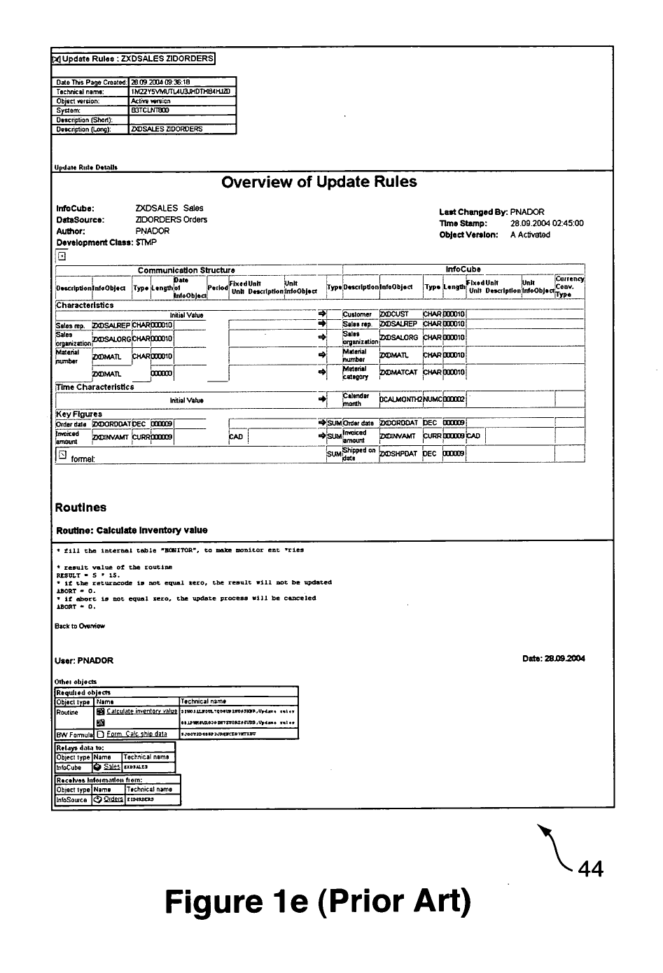

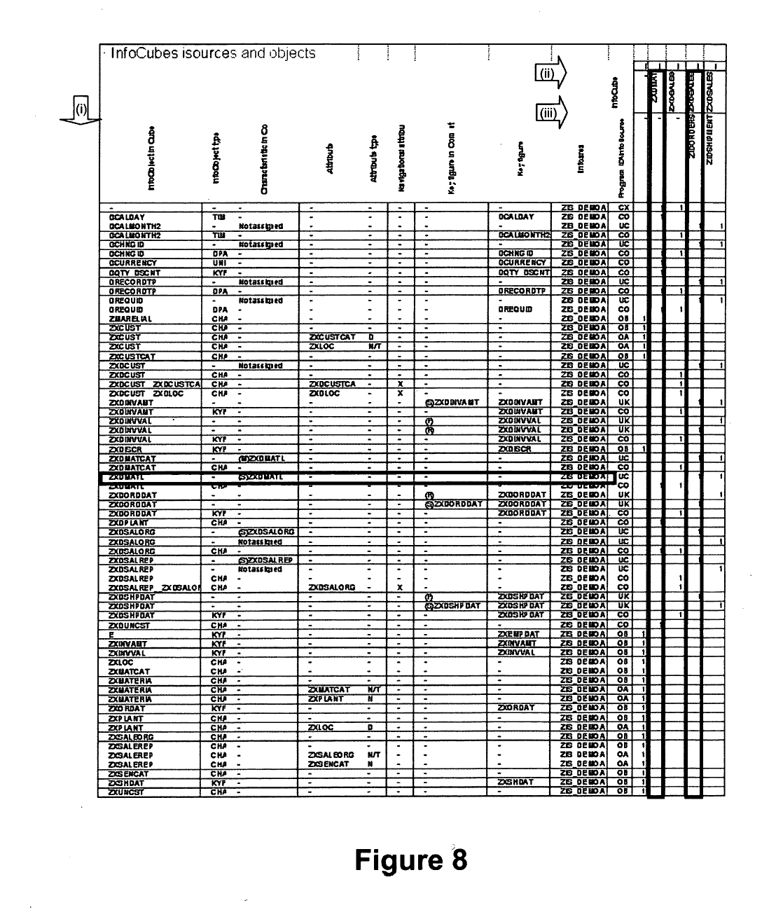

FIG. 8 highlights a portion of the report shown in FIG. 6 that contains the same information that was described above with reference to FIGS. 1c-1e using the SAP-BW metadata repository. As in FIG. 6, (i) displays all InfoObjects in the selected portion of the subject system 90; (ii) displays all InfoCubes in the selected portion of the subject system 90; and (iii) displays information about all InfoSources in the selected portion of the subject system 90. As will be understood by those skilled in the art, to obtain equivalent information from a full implementation of the subject system 90, the number of screens required to be displayed using the SAP-BW metadata repository increases proportionally with the increase in the complexity of the system. However, using the reports shown in FIGS. 6-8, the user is provided with information about all interrelations among components, permitting rapid and accurate understanding of the configuration of the subject system 90.

Although the invention has been explained by way of example with reference to the SAP-BW OLAP system, it should be understood, as explained above, that the host system of the invention can be implemented using any known OLAP system and that the advantages of the invention can be realized regardless of the OLAP system used to implement the invention.

The embodiment(s) of the invention described above are intended to be exemplary only. The scope of the invention is therefore intended to be limited solely by the scope of the appended claims.

I claim:

1. A system for assisting in the design, implementation and documentation of a subject online analytical processing system, comprising:
a plurality of extractor programs for respectively extracting data from one of: a table of the subject online analytical processing system, and a view of two or more of the tables; and
an extracted data table for receiving data extracted by the plurality of extractor programs, the extracted data table serving as an information source for a master information cube of a host online analytical processing system that stores data for permitting users to generate reports about the online analytical processing system.

2. The system as claimed in claim 1 further comprising data staging facilities of the host online analytical processing system configured to transfer data from the extracted data table to the master information cube.

3. The system as claimed in claim 2 wherein the configured staging facilities comprise at least one of: an information package; a transfer rule; and an update rule.

4. The system as claimed in claim 1 wherein the extracted data table is in a comma-delimited file format with header information.

5. The system as claimed in claim 1 wherein the extracted data table is in a file format supported by the host online analytical processing system.

6. The system as claimed in claim 1 wherein the reports are generated using query and reporting facilities of the host online analytical processing system.

7. The system as claimed in claim 1 further comprising an extractor program generator for generating the plurality of extractor programs.

8. The system as claimed in claim 7 wherein the extractor program generator receives input parameters that describe a mapping between the one of the table and the view and fields of the extracted data table.

9. The system as claimed in claim 1 wherein the plurality of extractor programs respectively accept parameter input for controlling how output to the extracted data table is handled.

10. The system as claimed in claim 4 further comprising a spreadsheet for receiving the data in the comma-delimited file format and capturing new design information about the online analytical processing system.

11. A method of assisting in the design, implementation and documentation of a subject online analytical processing system, comprising:
providing a plurality of extractor programs for respectively extracting data from one of: a table of the online analytical processing system, and a view of two or more of the tables;
providing at least one extracted data table for receiving data extracted by the plurality of extractor programs, each extracted data table serving as an information source for a master information cube of a host online analytical processing system that stores the data; and
structuring data staging facilities of the host online analytical processing system to transfer the data from the extracted data table to the master information cube to permit users to generate reports about the online analytical processing system.

12. The method as claimed in claim 11 wherein structuring the host data staging facilities comprises providing at least one of an information package, an information source transfer rule and a data transfer update rule.

13. The method as claimed in claim 11 further comprising providing an extractor program generator that accepts parameter input describing the one of the data table and the view and parameters that govern how data is to be extracted from the one of the data table and the view and generates a one of the extractor programs based on the parameter input.

14. The method as claimed in claim 11 wherein providing the extracted data table comprises providing a data table in a comma-delimited file format.

15. The method as claimed in claim 14 further comprising providing a spreadsheet configured to accept data transferred from the extracted data table and to extract new design information about the subject online analytical processing system.

16. The method as claimed in claim 15 further comprising providing control buttons within the spreadsheet to control displayed rows and displayed columns to permit the users to personalize data displayed in the spreadsheet based on user identification.

17. The method as claimed in claim 11 wherein providing the extracted data table comprises providing a data table in a format supported by the host online analytical processing system.

18. The method as claimed in claim 11 wherein permitting users to generate reports about the subject online analytical processing system comprises configuring a query and reporting system of the host online analytical processing system to generate the reports in response to user queries.

19. The method as claimed in claim 18 wherein the subject online analytical processing system and the host online analytical processing system are the same online analytical processing system.

20. The method as claimed in claim 19 wherein the online analytical processing system comprises a SAP AG business information warehouse system (SAP-BW).
